(19) United States
(12) Patent Application Publication
(10) Pub. No.: US 2013/0139552 A1
(43) Pub. Date: Jun. 6, 2013

(54) METHOD FOR MANUFACTURING TEMPERED-GLASS PANELS FOR ELECTRONIC DEVICES

(71) Applicant: Samsung Electronics Co. Ltd., Suwon-si (KR)

(72) Inventor: Hakyeol KIM, Hwaseong-si (KR)

(73) Assignee: SAMSUNG ELECTRONICS CO. LTD., Suwon-si (KR)

(21) Appl. No.: 13/684,836

(22) Filed: Nov. 26, 2012

(30) Foreign Application Priority Data
Dec. 1, 2011 (KR) 10-2011-0127546

(51) Int. Cl. C03C 21/00; C03C 17/00; C03B 33/02

(52) U.S. Cl. CPC C03C 21/00; C03B 33/02; C03C 17/001
USPC 65/30.14; 65/174

(57) ABSTRACT

A method for manufacturing tempered-glass panels for electronic devices is provided. The method includes pre-processing an original glass substrate so as to reduce weak portions that are formed in the original glass substrate when the original glass substrate is first tempered and then processed tempering the pre-processed original glass substrate and cutting the tempered pre-processed original glass substrate to produce a number of tempered-glass panels. The method can produce the tempered-glass panels from the original glass substrate, maintaining a certain level of production efficiency.

### PRIORITY

This application claims the benefit under 35 U.S.C. §119(a) of a Korean patent application filed on Dec. 1, 2011 in the Korean Intellectual Property Office and assigned Serial No. 10-2011-0127546, the entire disclosure of which is hereby incorporated by reference.

### BACKGROUND OF THE INVENTION

1. Field of the Invention

The present invention relates to a method for manufacturing tempered-glass panels for electronic devices. More specifically, the present invention relates to a method for manufacturing tempered-glass panels for electronic devices from an original glass substrate in such a way as to temper the weak portions, such as, holes, edges, and the like, which are created when the glass is first tempered and then processed, while maintaining a certain level of production efficiency.

2. Description of the Related Art

Electronic devices are designed to be thin. Electronic devices employ tempered-glass panels to protect their screens. Tempered-glass panels according to the related art are manufactured in such a way that an original glass substrate is tempered; holes, decorations, and electrodes are printed on the tempered original glass substrate according to the designs of electronic devices; and the final substrate is cut to produce a number of tempered-glass panels. However, because the original glass substrate is tempered and then cut, the glass substrate may not be uniformly tempered, Such non-uniformed tempering of the glass substrate causes the tempered-glass panels to have weak portions. For example, if an original glass substrate is tempered and then cut to meet the size of display screen for an electronic device, the cut plane has not been tempered. If holes are formed in an original glass substrate, the area with the holes has not been tempered. That is, if tempered-glass panels are produced in such a way that an original glass substrate is first tempered and then processed, they may include the weak portions such as holes, edges, and the like. In that case, the tempered-glass panels may be broken down by impact.

Meanwhile, the tempered-glass panels may be produced in such a way that the original glass substrate is cut to a number of glass panels and the number of glass panels are then respectively tempered. However, such a method of manufacturing the glass panels increases the manufacturing cost of the tempered-glass panels.

Therefore, a need exists for a system and method for manufacturing tempered-glass panels for electronic devices from an original glass substrate in such a way as to temper the weak portions, such as, holes, edges, and the like, which are created when it is first tempered and then processed, while maintaining a certain level of production efficiency.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a method for manufacturing tempered-glass panels for electronic devices from an original glass substrate in such a way as to temper the weak portions, such as, holes, edges, etc., which are created when it is first tempered and then processed, while maintaining a certain level of production efficiency.

In accordance with an aspect of the present invention, a method for manufacturing tempered-glass panels for electronic devices is provided. The method includes pre-processing an original glass substrate so as to reduce weak portions that are formed in the original glass substrate when the original glass substrate is first tempered and then processed, tempering the pre-processed original glass substrate, and cutting the tempered pre-processed original glass substrate to produce a number of tempered-glass panels.

In accordance with another aspect of the present invention, a system for manufacturing tempered-glass panels for electronic devices is provided. The system includes a control unit that is configured for operatively controlling pre-processing an original glass substrate so as to reduce weak portions that are formed in the original glass substrate when the original glass substrate is first tempered and then processed, for operatively controlling tempering the pre-processed original glass substrate, and for operatively controlling cutting the tempered pre-processed original glass substrate to produce a number of tempered-glass panels.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a flow chart that describes a method for manufacturing tempered-glass panels for electronic devices according to an exemplary embodiment of the present invention;

FIG. 2 illustrates views to describe a method for manufacturing tempered-glass panels for electronic devices according to a first exemplary embodiment of the present invention; and

FIG. 3 illustrates views to describe a method for manufacturing tempered-glass panels for electronic devices according to a second exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

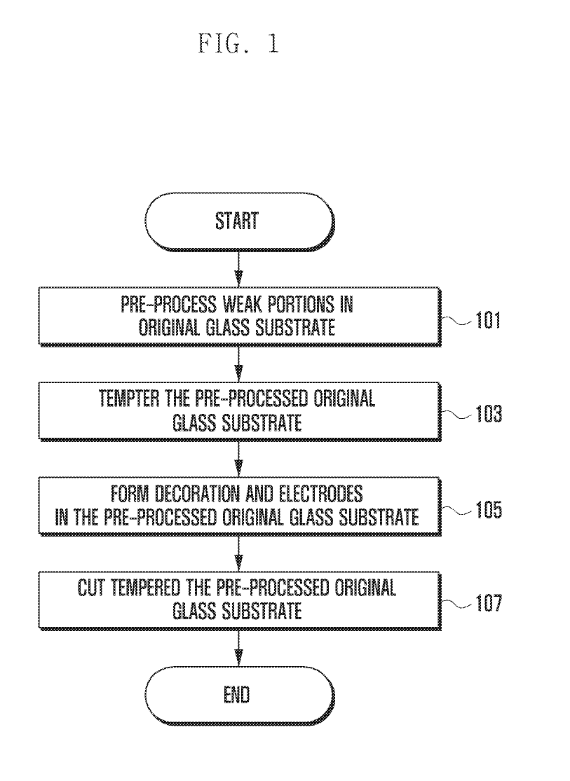

FIG. 1 illustrates a flow chart that describes a method for manufacturing tempered-glass panels for electronic devices according to an exemplary embodiment of the present invention.

Referring to FIG. 1, at step 101 weak portions in an original glass substrate are pre-processed before the glass substrate is used to produce tempered-glass panels for electronic devices. As an example, weak portions refer to portions of the glass substrate that may be broken down by impact. Consequently, it is advantageous to ensure that the weak portions of the glass substrate are tempered. Weak portions may be created when an original glass substrate is first tempered and then processed. For example, weak portions may be holes, edges and straight sections equal to or less than a certain length, which are formed in a tempered-glass panel for an electronic device. According to exemplary embodiments of the present invention, the pre-processing of an original glass substrate includes at least one of the following: forming the holes in the respective tempered-glass panels; processing the respective tempered-glass panels so that the edges can be exposed to the outside; and processing the respective tempered-glass panels so that the straight sections can be exposed to the outside.

After the pre-processing of weak portions is completed, the method proceeds to step 103. At step 103, the processed original glass substrate is tempered. For example, the holes, edges and straight sections equal to or less than a certain length, are tempered. The processed original glass substrate may be tempered via a chemical tempering method. For example, the chemical tempering method is performed in such a way that a glass substrate is immersed in a solution of KNO3, at a certain temperature, for a certain period of time, where Na+ in the glass is substituted with K+ in the KNO3 solution. As an example, the strength of glass substrate is determined according to the degree of substitution of K+ in the KNO3 solution for Na+ in the glass.

After tempering the pre-processed original glass substrate at step 103, decorations and/or electrodes are formed in the substrate at step 105. According to exemplary embodiments of the present invention, decorations and electrodes may be formed with respect to the pre-processed weak portions. As an example, the decorations refer to patterns or designs formed on the tempered-glass panel for electronic devices. The electrodes serve to sense touches. According to an exemplary embodiment of the present invention, the decorations and the electrodes may be formed via a printing, coating, or depositing process. According to another exemplary embodiment of the present invention, the tempered-glass panel may be implemented without decorations and electrodes according to types of electronic devices.

After decorations and/or electrodes are formed in the substrate at step 105, the original glass substrate is cut to a number of tempered-glass panels in preset size at step 107. Because the weak portions have been tempered in the tempered-glass panels, such portions cannot be broken down by impact.

As described above, because an original glass substrate is pre-processed so that the weak portions, such as holes, edges, and straight sections equal to or less than a certain length, can be exposed, and then tempered, the weak portions previously experience the tempering process. Therefore, exemplary embodiments of the present invention can resolve problems associated with the related art in which holes or edges are broken down because the original glass substrate is first tempered and then processed. Exemplary embodiments of the present invention can also maintain a certain level of production efficiency of tempered-glass panels.

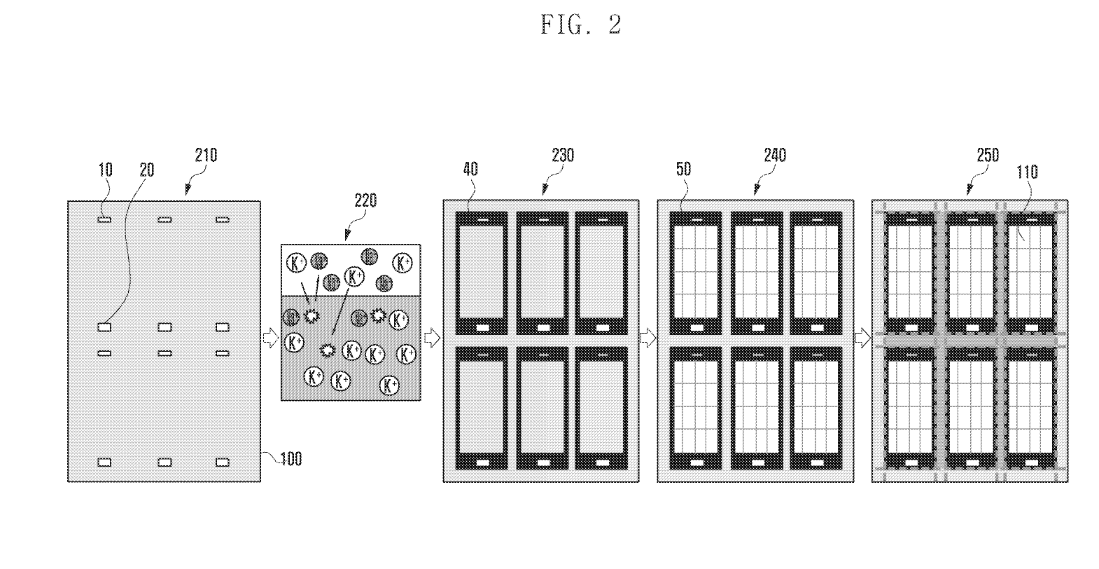

FIG. 2 illustrates views to describe a method for manufacturing tempered-glass panels for electronic devices according to a first exemplary embodiment of the present invention. The first exemplary embodiment of the present invention is described where holes are tempered.

As shown in diagram 210, a number of first holes 10 and second holes 20 are previously processed in an original glass substrate 100 that is used to produce a number of tempered-glass panels. According to an exemplary embodiment of the present invention, if an electronic device employing the tempered-glass panel is a mobile device, the first holes 10 are each formed at locations in the original glass substrate 100, corresponding to a speaker, and the second holes 20 are each formed at locations corresponding to a function key (e.g., a home key). The number of first holes 10 and the number of second holes 20 each correspond to the number of tempered-glass panels 110. For example, as shown in diagram 210, the original glass substrate 100 has six first holes 10 and six second holes 20.

After the number of first holes 10 and second holes 20 have been pre-processed in the original glass substrate 10, the preprocessed original glass substrate 100 is tempered as shown in diagram 220. This process tempers the first 10 and second 20 holes, which according to the related art, are weak. In an exemplary embodiment of the present invention, the tempering process may be implemented with a chemical process as described above.

After tempering the original glass substrate 100, decorations 40 are formed on thereon as shown in diagram 230 and electrodes 50 are then formed thereon as shown in diagram 240. As an example, the electrodes 50 may be implemented with touch sensors for sensing touches. According to exemplary embodiments of the present invention, the decorations and the electrodes may be formed via a printing, coating, or depositing process. According to exemplary embodiments of the present invention, the decorations and the electrodes may not be formed on the tempered original glass substrate 100 according to types of electronic devices that will employ the tempered-glass panels.

After forming the electrodes 50, the original glass substrate 100, experiencing first a previous process and then a tempering process, is cut to produce a number of tempered-glass panels 110 (e.g., six), as shown in diagram 250. As described above, the exemplary embodiment of the present invention was described in such a way that the tempering process is applied to holes in an original glass substrate. The following description explains the tempering process applied to edges in an original glass substrate.

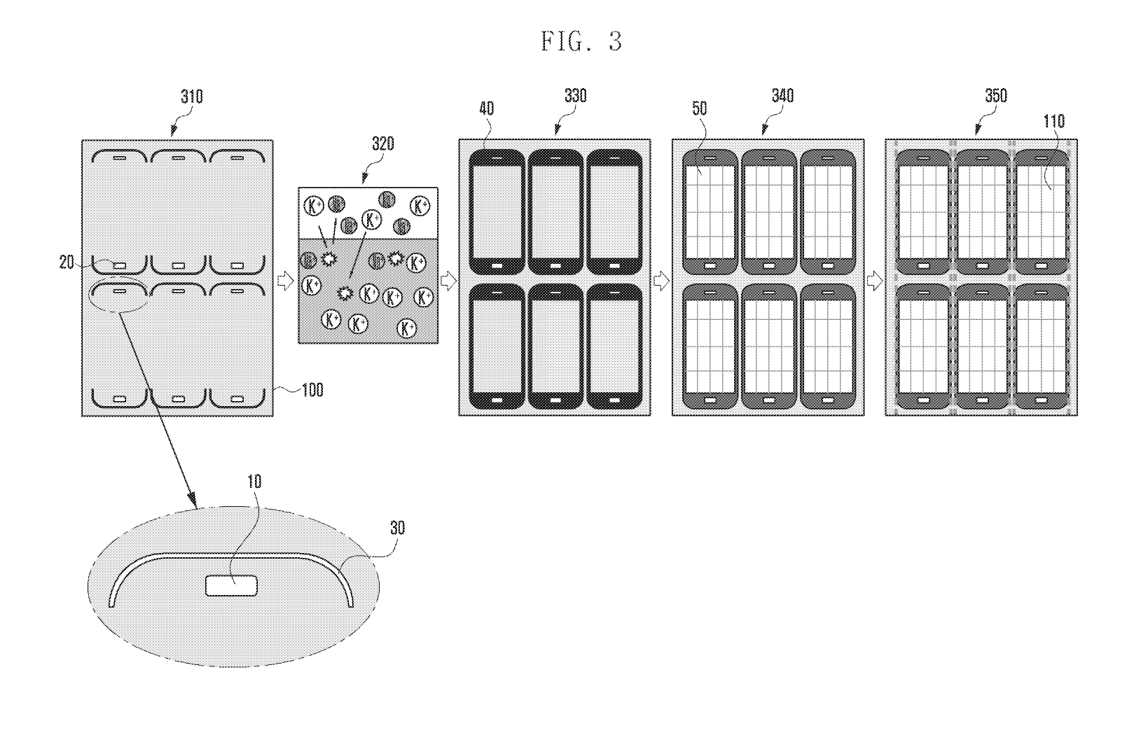

FIG. 3 illustrates views to describe a method for manufacturing tempered-glass panels for electronic devices according to a second exemplary embodiment of the present invention. The second exemplary embodiment of the present invention is described where edges are tempered.

As shown in diagram 310, first holes 10 and second holes 20, and edges 30 are previously processed in an original glass substrate 100 that is used to produce a number of tempered-glass panels. The number of first holes 10, the number of second holes 20, and the number of edges 30 each correspond to the number of tempered-glass panels 110. For example, as shown in diagram 310, the original glass substrate 100 has six first holes 10, six second holes 20, and six edges 30. According to exemplary embodiments of the present invention, the edges 30 are designed to be curved in order to increase the strength. The edges 30 and the cut sides are chamfered.

After that, the preprocessed original glass substrate 100 is tempered as shown in diagram 320. This process tempers the first holes 10 and second holes 20, and the edges 30, which according to the related art, are weak. In an exemplary embodiment of the present invention, the tempering process may be implemented with a chemical process as described above.

After tempering the original glass substrate 100, decorations 40 are formed on thereon as shown in diagram 330 and electrodes 50 are then formed thereon as shown in diagram 340. The electrodes 50 may be implemented with touch sensors for sensing touches. The decorations and the electrodes may be formed via a printing, coating, or depositing process. According to exemplary embodiments of the present invention, the decorations and the electrodes may not be formed on the tempered original glass substrate 100 according to types of electronic devices that will employ the tempered-glass panels.

After forming the electrodes 50, the original glass substrate 100, experiencing first a previous process and then a tempering process, is cut to produce a number of tempered-glass panels 110 (e.g., six), as shown in diagram 350.

As described above, the exemplary embodiment of the present invention was described in such a way that the tempering process is applied to holes in an original glass substrate. The following description explains the tempering process applied to edges in an original glass substrate.

As described above, the method first processes the original glass substrate 100 in such a way that the holes, edges, and straight sections equal to or less than a certain length can be exposed to the outside, and then tempers the pre-processed original glass substrate 100, thereby tempering the holes, edges, and straight sections. Therefore, the method can prevent the portions that were identified as being weak according to the related art (i.e., the weak portions), from being broken down. For example, the weak portions may correspond to the holes, edges, and straight sections, from being broken down. In addition, because the method tempers the original glass substrate, the method can maintain a certain level of production efficiency of the tempered-glass panels. In contrast, the related art cuts the original glass substrate to a number of glass panels and then respectively tempers the glass panels.

As described above, exemplary embodiments of the present invention of a method for manufacturing tempered-glass panels for electronic devices can increase the strength of the cut portions, such as, for example, holes, edges, and the like, which are created when it is first tempered and then processed. Therefore, the method can enhance the reliability in the tempered-glass panel for an electronic device. In addition, because, according to exemplary embodiments of the present invention, the original glass substrate is tempered, the exemplary embodiments of the present invention can maintain a certain level of process efficiency while tempered-glass panels are produced from the tempered original glass substrate.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for manufacturing tempered-glass panels for electronic devices, the method comprising:
pre-processing an original glass substrate so as to reduce weak portions that are formed in the original glass substrate when the original glass substrate is first tempered and then processed;
tempering the pre-processed original glass substrate; and
cutting the tempered pre-processed original glass substrate to produce a number of tempered-glass panels.

2. The method of claim 1, wherein the weak portions comprise:
at least one of holes, edges, and straight sections equal to or less than a predetermined length.

3. The method of claim 2, wherein the pre-processing of the original glass substrate comprises at least one of the following:
forming the holes in the original glass substrate;
processing the original glass substrate so that the edges can be exposed to the outside; and
processing the original glass substrate so that the straight sections can be exposed to the outside.

4. The method of claim 3, wherein the pre-processing of the original glass substrate further comprises:
curving or chamfering the edges.

5. The method of claim 2, wherein the tempering the pre-processed original glass substrate comprises:
tempering the at least one of holes, the edges, and the straight sections, which are exposed to the outside.

6. The method of claim 1, further comprising:
forming decorations in the pre-processed original glass substrate.

7. The method of claim 1, wherein the decorations are formed by one of a printing process, a coating process, and a depositing process.

8. The method of claim 1, further comprising:
forming electrodes, for sensing the presence of touch on the respective tempered-glass panels, in the original glass substrate.

9. The method of claim 8, wherein the electrodes are formed by one of a printing process, a coating process, or a depositing process.

10. A system for manufacturing tempered-glass panels for electronic devices, the system comprising:
a control unit that is configured for operatively controlling pre-processing an original glass substrate so as to reduce weak portions that are formed in the original glass substrate when the original glass substrate is first tempered and then processed, for operatively controlling tempering the pre-processed original glass substrate, and for operatively controlling cutting the tempered pre-processed original glass substrate to produce a number of tempered-glass panels.

11. The system of claim 10, wherein the weak portions comprise:
at least one of holes, edges, and straight sections equal to or less than a predetermined length.

12. The system of claim 11, wherein the control unit is further configured for operatively controlling pre-processing of the original glass substrate such that the control unit operatively controls at least one of the following:
forming the holes in the original glass substrate;
processing the original glass substrate so that the edges can be exposed to the outside; and
processing the original glass substrate so that the straight sections can be exposed to the outside.

13. The system of claim 12, wherein the control unit is further configured for operatively controlling pre-processing of the original glass substrate such that the control unit operatively controls curving or chamfering the edges.

14. The system of claim 11, wherein the control unit is further configured for operatively controlling tempering the pre-processed original glass substrate such that the control unit operatively controls tempering the at least one of holes, the edges, and the straight sections, which are exposed to the outside.

15. The system of claim 10, wherein the control unit is further configured for operatively controlling forming decorations in the pre-processed original glass substrate.

16. The system of claim 10, wherein the decorations are formed by one of a printing process, a coating process, and a depositing process.

17. The system of claim 10, wherein the control unit is further configured for operatively forming electrodes, for sensing the presence of touch on the respective tempered-glass panels, in the original glass substrate.

18. The system of claim 17, wherein the electrodes are formed by one of a printing process, a coating process, or a depositing process.
